(19) United States
(12) Patent Application Publication
(10) Pub. No.: US 2023/0148158 A1
(43) Pub. Date: May 11, 2023

(54) METHOD AND SYSTEM FOR MANAGING CLOUD RESOURCES

(71) Applicant: Diamanti Inc., San Jose, CA (US)

(72) Inventors: Sambasiva Rao Bandarupalli, Sunnyvale, CA (US); Kshitij Gunjikar, Fremont, CA (US)

(21) Appl. No.: 17/984,016

(22) Filed: Nov. 9, 2022

Related U.S. Application Data
(60) Provisional application No. 63/277,452, filed on Nov. 9, 2021.

(51) Int. Cl. H04L 67/1008; H04L 67/1087; H04L 67/1012

(52) U.S. Cl. CPC H04L 67/1008; H04L 67/1012; H04L 67/1089

(57) ABSTRACT

In an embodiment of the present disclosure, a processor selects first and second policies of a plurality of policies enabled for enforcement in a cluster, each of the first and second policies comprising a set of rules and corresponding to a different set of operations performed in the cluster, wherein first and second sets of operations correspond to the first and second policies, respectively, and define, respectively, differing first and second policy types and, in response to determining that the first and second policies correspond to differing first and second policy types, merges the first and second policies into an aggregate policy to be enforced at a selected hierarchical level.

### CROSS REFERENCE TO RELATED APPLICATION

The present application claims the benefits of U.S. Provisional Application Serial No. 63/277,452, filed Nov. 9, 2021, entitled “Method and System for Managing Cloud Resources,” which is incorporated herein by this reference in its entirety.

### FIELD

The present disclosure relates generally to distributed processing systems and particularly to cloud computing systems.

### BACKGROUND

A computer cluster is a set of computers that work together so that they can be viewed as a single system and execute in parallel to allow workloads including a high number of individual, parallelizable tasks to be distributed among the nodes in the cluster. As a result, these tasks can leverage the combined memory and processing power of each computer to increase overall performance. Cloud-based computer clusters typically provide Platform-as-a-Service (PaaS), Infrastructure-as-a-Service (IaaS), and storage, and other services to tenants. While clusters can provide high availability, load balancing, scaling, and high performance, clusters pose management challenges due to their complexity caused by installing on each computer an operating system, the application, and its dependencies, particularly in cloud computing applications.

### SUMMARY

In an embodiment, a method of enabling policy management in a multi-cluster cloud computing environment can include the steps of:
selecting first and second policies of a plurality of policies enabled for enforcement in a cluster, each of the first and second policies comprising a set of rules and corresponding to a different set of operations performed in the cluster, wherein first and second sets of operations correspond to the first and second policies, respectively, and define, respectively, differing first and second policy types; and
in response to determining that the first and second policies correspond to differing first and second policy types, merging the first and second policies into an aggregate policy to be enforced at a selected hierarchical level. As used herein, a policy refers to a set of rules. In contrast, a state defines configurations or other parameters or attributes at an object level to operate on or implement defined policies.

In an embodiment, a system for enabling policy management in a multi-cluster cloud computing environment can include:
a communication interface to transmit and receive communications;
a processor coupled with the communication interface; and
a computer readable medium, coupled with and readable by the processor and storing therein a set of instructions that, when executed by the processor, causes the processor to:
select first and second policies of a plurality of policies enabled for enforcement in a cluster, each of the first and second policies comprising a set of rules and corresponding to a different set of operations performed in the cluster, wherein first and second sets of operations correspond to the first and second policies, respectively, and define, respectively, differing first and second policy types;
in response to determining that the first and second policies correspond to differing first and second policy types, merge the first and second policies into an aggregate policy to be enforced at a selected hierarchical level.

In an embodiment, a multi-tenant, multi-cluster environment can include:
a plurality of tenant clusters; and
a domain cluster communicatively coupled with each of the plurality of tenant clusters, the domain cluster comprising a processor and a memory coupled with and readable by the processor and storing therein a set of instructions which, when executed by the processor, causes the processor to:
select first and second policies of a plurality of policies enabled for enforcement in a cluster, each of the first and second policies comprising a set of rules and corresponding to a different set of operations performed in the cluster, wherein first and second sets of operations correspond to the first and second policies, respectively, and define, respectively, differing first and second policy types;
in response to determining that the first and second policies correspond to differing first and second policy types, merge the first and second policies into an aggregate policy to be enforced at a selected hierarchical level.

The selected hierarchical level can include one or more of service provider, tenant, project, and application.

The first and second policies can correspond to different first and second hierarchical levels, respectively. The selected hierarchical level can be a higher of the first and second hierarchical levels, and the aggregate policy can be enforced at one or more hierarchical levels below the selected hierarchical level.

The processor can identify, for each of the first and second policy types, one or more policies enabled for enforcement at each of the hierarchical levels and apply a rule that, when plural policies of a common policy type are enabled for enforcement at different hierarchical levels, specifies that an enabled policy at a higher hierarchical level supersedes an enabled policy at a lower hierarchical level.

The first and second policy types can correspond to differing ones of storage, network, security, resource limit, and performance.

Each of the first and second policies can correspond to a policy state, the corresponding policy state comprising a checksum of generated policies based on the corresponding policy state, and the processor can validate each of the first and second policies using a checksum corresponding to the first and second policy types, respectively.

The present disclosure can provide a number of advantages depending on the particular configuration. For example, the system of the present disclosure can enable not only high availability, load balancing, scaling, and high performance but also provide a policy management tool that creates, updates, and verifies policies using a central policy enforcement point that overcomes challenges due to cloud-based cluster complexity. Policies can flow from the top level to bottom level rather than bottom level to top level. Policies can be scalable and flexible by providing separate available and enforced policies.

These and other advantages will be apparent from the disclosure contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means: A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also notable that the terms “comprising”, “including”, and “having” can be used interchangeably.

The term “application containerization” may be used to refer to an operating system-level virtualization method that deploys and runs distributed applications or virtualized applications (e.g., containerized or virtual machine-based applications) without launching an entire virtual machine for each application. Multiple isolated applications or services may run on a single host and access the same operating system kernel.

The term “automatic” and variations thereof may refer to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” may refer to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The term “cluster” may refer to a group of multiple worker nodes that deploy, run and manage containerized or VM-based applications and a master node that controls and monitors the worker nodes. A cluster can have an internal and/or external network address (e.g., DNS name or IP address) to enable communication between containers or services and/or with other internal or external network nodes.

The term “container” may refer to a form of operating system virtualization that enables multiple applications to share an operating system by isolating processes and controlling the amount of processing resources (e.g., central processing unit (CPU), graphics processing unit (GPU), etc.), memory, and disk those processes can access. While containers like virtual machines share common underlying hardware, containers, unlike virtual machines they share an underlying, virtualized operating system kernel and do not run separate operating system instances.

The term “D10/D20 Node” may refer to a Converged Networking/Storage Server and is a platform to manage a single cluster.

The term “DCX” refers to an illustrative, but non-limiting, container platform, such as a Diamanti Container Platform.

The terms “determine”, “calculate” and “compute,” and variations thereof are used interchangeably and include any type of methodology, process, mathematical operation or technique.

The term “deployment” may refer to control of the creation, state and/or running of containerized or VM-based applications. It can specify how many replicas of a pod should run on the cluster. If a pod fails, the deployment may be configured to create a new pod.

The term “domain” may refer to a set of objects that define the extent of all infrastructure under management within a single context. Infrastructure may be physical or virtual, hosted on-premises or in a public cloud. Domains may be configured to be mutually exclusive, meaning there is no overlap between the infrastructure within any two domains.

The term “domain cluster” may refer to the primary management cluster and is the operational center for Spektra™. This may be the first cluster provisioned.

The term “Istio service mesh” may refer to a service mesh layer for containers that adds a sidecar container to each cluster that configures, monitors, and manages interactions between the other containers.

The term “Knative” may refer to a platform that sits on top of containers and enables developers to build a container and run it as a software service or as a serverless function. It can enable automatic transformation of source code into a clone container or functions; that is, Knative may automatically containerize code and orchestrate containers, such as by configuration and scripting (such as generating configuration files, installing dependencies, managing logging and tracing, and writing continuous integration/continuous deployment (CI/CD) scripts. Knative can perform these tasks through build (which transforms stored source code from a prior container instance into a clone container or function), serve (which runs containers as scalable services and performs configuration and service routing), and event (which enables specific events to trigger container-based services or functions).

The term “master node” may refer to the node that controls and monitors worker nodes. The master node may run a scheduler service that automates when and where containers are deployed based on developer-set deployment requirements and available computing capacity.

The term “module” may refer to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

The term “namespace” may refer to a set of signs (names) that are used to identify and refer to objects of various kinds. In Kubernetes, for example, there are three primary namespaces: default, kube-system (used for Kubernetes components), and kube-public (used for public resources). Namespaces are intended for use in environments with many users spread across multiple teams, or projects. Namespaces may not be nested inside one another, and each Kubernetes resource may be configured to only be in one namespace. Namespaces may provide a way to divide cluster resources between multiple users (via resource quota). At a high level, the extension to namespaces enables multiple virtual clusters (or namespaces) backed by a common set of physical (Kubernetes) cluster.

The term “pods” may refer to groups of containers that share the same compute resources and the same network.

The term “project” may refer to a set of objects within a tenant that contains applications. A project may act as an authorization target and allow administrators to set policies around sets of applications to govern resource usage, cluster access, security levels, and the like. The project construct can enable authorization (e.g., Role Based Access Control or RBAC), application management, and the like within a project. In one implementation, a project is an extension of Kubernetes’ use of namespaces for isolation, resource allocation and basic authorization on a cluster basis. Project may extend the namespace concept by grouping together multiple namespaces in the same cluster or across multiple clusters. Stated differently, projects can run applications on one cluster or on multiple clusters. The resources are allocated per project basis.

The term “project administrator” or “project admin” or PA may refer to the entity or entities responsible for adding members to a project, manages users to a project, manages applications that are part of a project, specifies new policies to be enforced in a project (e.g., with respect to uptime, SLAs, and overall health of deployed applications), etc.

The term “project member” or PM may refer to the entity or entities responsible for deploying applications on Kubernetes in a project, responsible for uptime, service level agreements (“SLAs”), and overall health of deployed applications. The PM may not have permission to add a user to a project.

The term “project viewer” or PV may refer to the interface that enables a user to view all applications, logs, events, and other objects in a project.

The term “resource”, when used with reference to Kubernetes, may refer to an endpoint in the Kubernetes API that stores a collection of API objects of a certain kind; for example, the built-in pods resource contains a collection of pod objects.

The term “serverless computing” may refer to a way of deploying code that enables cloud native applications to bring up the code as needed; that is, it can scale it up or down as demand fluctuates and take the code down when not in use. In contrast, conventional applications deploy an ongoing instance of code that sits idle while waiting for requests.

The term “service” may refer to an abstraction, which defines a logical set of pods and a policy by which to access them (sometimes this pattern is called a micro-service).

The term “service provider” or SP may refer to the entity that manages the physical/virtual infrastructure in domains. In one implementation, a service provider manages an entire node inventory and tenant provisioning and management. Initially a service provider manages one domain.

The term “service provider persona” may refer to the entity responsible for hardware and tenant provisioning or management.

The term “Spektra” may refer to a Diamanti™ multi-cloud product.

The term “tenant” may refer to an organizational construct or logical grouping used to represent an explicit set of resources (e.g., physical infrastructure (e.g., CPUs, GPUs, memory, storage, network, and , cloud clusters, people, etc.) within a domain. Tenants “reside” within infrastructure managed by a service provider. By default, individual tenants do not overlap or share anything with other tenants; that is, each tenant can be data isolated, physically isolated, and runtime isolated from other tenants by defining resource scopes devoted to each tenant. Stated differently, a first tenant can have a set of resources, resource capabilities, and/or resource capacities that is different from that of a second tenant. Service providers assign worker nodes to a tenant, and the tenant admin forms the clusters from the worker nodes.

The term “tenant administrator” or “tenant admin” or TA may refer to the entity responsible for managing an infrastructure assigned to a tenant. The tenant administrator is responsible for cluster management, project provisioning, providing user access to projects, application deployment, specifying new policies to be enforced in a tenant, etc.

The term “tenant cluster” may refer to clusters of resources assigned to each tenant upon which user workloads run. The domain cluster performs lifecycle management of the tenant clusters.

The term “virtual machine” may refer to a server abstracted from underlying computer hardware so as to enable a physical server to run multiple virtual machines or a single virtual machine that spans more than one server. Each virtual machine typically runs its own operating system instance to permit isolation of each application in its own virtual machine, reducing the chance that applications running on common underlying physical hardware will impact each other.

The term “volume” may refer to a volume of memory of a selected size that is created from a distributed storage pool of memory. When a volume is created, a scheduler may automatically select an optimum node on which to create the volume. A “mirrored volume” refers to synchronous cluster-local data protection while “replicated volume” refers to asynchronous cross-cluster data protection.

The term “worker node” may refer to the compute resources and network(s) that deploy, run, and manage containerized or VM-based applications. Each worker node contains the services to manage the networking between the containers, communication with the master node, and assign resources to the containers scheduled. Each worker node can include a tool that is used to manage the containers, such as Docker, and a software agent called a Kubelet that receives and executes orders from the master node (e.g., the master API server). The Kubelet is a primary node agent which executes on each worker node inside the cluster. The Kubelet receives the pod specifications through an API server and executes the container associated with the pods and ensures that the containers described in the pods are running and healthy. If Kubelet notices any issues with the pods running on the worker nodes then it tries to restart the pod on the same node and if the issue is with the worker node itself then the master node detects the node failure and decides to recreate the pods on the other healthy node.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

FIG. 1 is a block diagram of a cloud-based architecture according to an embodiment of this disclosure;

FIG. 2 is a block diagram of an embodiment of the application management server;

FIG. 3 is a block diagram of a cloud-based architecture according to an embodiment of this disclosure;

FIG. 4 is a block diagram of a cloud-based architecture according to an embodiment of this disclosure;

FIG. 5 is a block diagram of a cloud-based architecture according to an embodiment of this disclosure;

FIG. 6 is a flow chart depicting disaster recovery controller logic according to an embodiment of this disclosure;

FIG. 7 is a flow chart depicting an authentication method according to an embodiment of this disclosure; and

FIG. 8 is a flow chart depicting a policy management method according to an embodiment of this disclosure.

### DETAILED DESCRIPTION

### Overview

The present disclosure is directed to a multi-cloud global platform (referenced herein as Spektra™) that provides a single plane of management console from which customers manage cloud-native applications and clusters and data using a policy-based management framework. The platform can be provided as a hosted service that is either managed centrally (such as by Diamanti) or deployed in customer environments. The customers could be enterprise customers or service providers. This platform can manage applications across multiple kubernetes clusters, which could be residing on-premises or in the cloud or combinations thereof (e.g., hybrid cloud implementations). The platform can provide abstract core networking and storage services on premises and in the cloud for stateful and stateless applications.

The platform can migrate data (including volume snapshots) and applications to any desired set of resources, provide failover stateful applications on premises, to the cloud or within the cloud. It can provide instant snapshots of containers or applications, mirroring or replicating of volumes, backup, and stateful or stateless application disaster recovery (DR) and data protection (DP).

Additionally, the platform can provide one or more of the following capabilities:
management of containerized or VM-based applications;
cluster management;
provision of projects to support multi-tenancy;
managed multi-cluster networking;
synchronous and asynchronous replication;
namespace-based isolation using overlay networking;
zone-aware network assignment and routing;
analytics, observability, AI/ML, logging, and/or supportability; and/or
third party integrations.

The platform can enable organizations to deliver a high-productivity Platform-as-a-Service (PaaS) that addresses multiple infrastructure-related and operations-related tasks and issues surrounding cloud-native development. It can support many container application platforms besides or in addition to Kubernetes, such as Red Hat, OpenShift, Docker, and other Kubernetes distributions, whether hosted or on-premises.

While this disclosure is discussed with reference to the Kubernetes container platform, it is to be appreciated that the concepts disclosed herein apply to other container platforms, such as Microsoft Azure™, Amazon Web Services™ (AWS), Open Container Initiative (OCI), CoreOS, and Canonical (Ubuntu) LXD™.

### The Multi-Cloud Global Platform

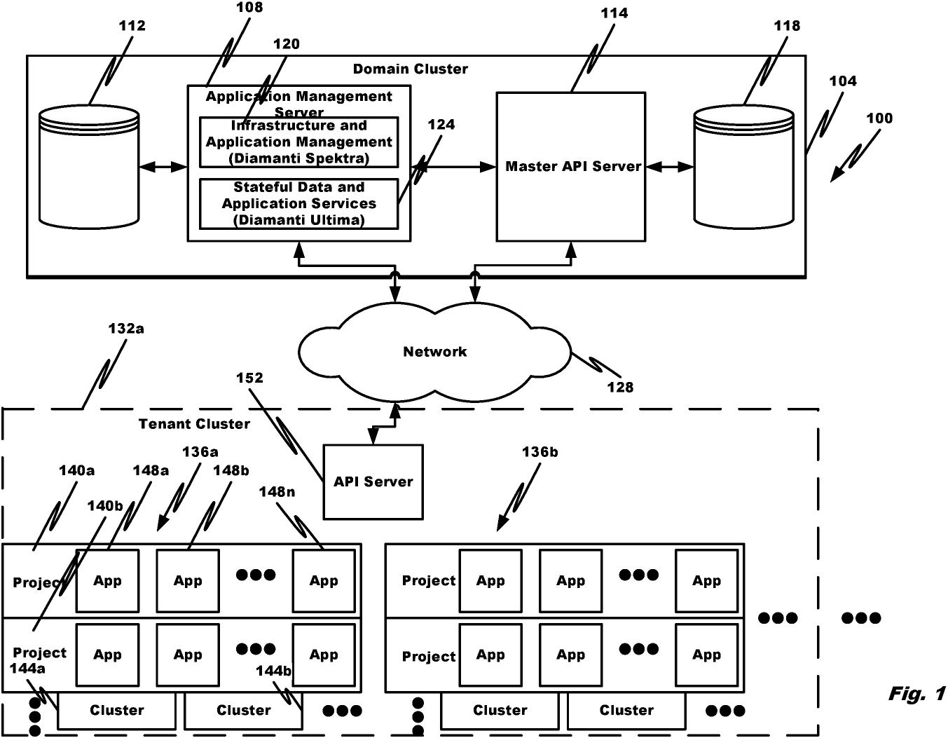

FIG. 1 depicts an embodiment of a multi-cloud global platform according to the present disclosure. The multi-cloud platform 100 is in communication, via network 128, with one or more tenant clusters 132a, ... Each tenant cluster 132a, ... corresponds to multiple tenants 136a, b, ..., with each of the multiple tenants 136a, b, ... in turn corresponding to a plurality of projects 140a, b, .. and clusters 144a, b, ... Each containerized or VM-based application 148a, b, ... n in each project 140a, b, ... utilizes the worker node resources in one or more of the clusters 144a, b, ...

To manage the tenant clusters 132a ... the multi-cloud global platform 100 is associated with a domain cluster 104 and comprises an application management server 108 and associated data storage 112 and master application programming interface (API) server 114, which is part of the master node (not shown) and associated data storage 118. The application management server 108 communicates with an application programming interface (API) server 152 assigned to the tenant clusters 132a ... to manage the associated tenant cluster 132a ... In some implementations, each cluster has a controller or control plane that is different from the application management server 108.

The servers 108 and 114 can be implemented as a physical (or bare-metal) server or cloud server. As will be appreciated, a cloud server is a physical and/or virtual infrastructure that performs application- and information-processing storage. Cloud servers are commonly created using virtualization software to divide a physical (bare metal) server into multiple virtual servers. The cloud server can use infrastructure-as-a-service (IaaS) model to process workloads and store information.

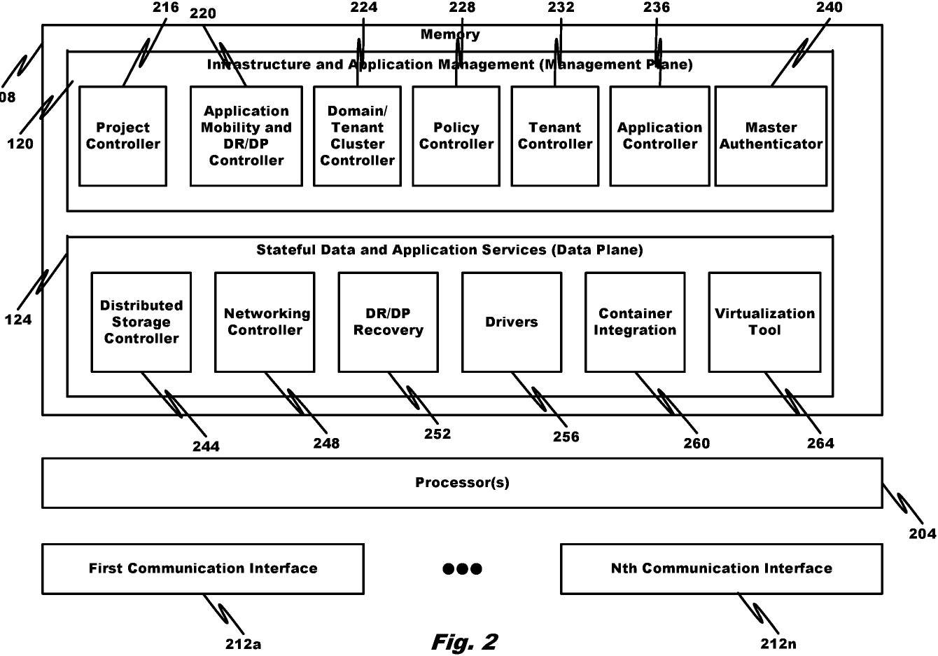

The application management server 108 performs tenant cluster management using two management planes or levels, namely an infrastructure and application management layer 120 and stateful and application services layer 124. The stateful and application services layer 124 can abstract network and storage resources to provide global control and persistence, span on-premises and cloud resources, provide intelligent placement of workloads based on logical data locality and block storage capacity. These layers are discussed in detail in connection with FIG. 2.

The API servers 114 and 152, which effectively act as gateways to the clusters, are commonly each implemented as a Kubernetes API server that implements a RESTful API over HTTP, performs all API operations, and is responsible for storing API objects into a persistent storage backend. Because all of the API server’s persistent state is stored in external storage (which is one or both of the databases 112 and 118 in the case of master API server 112) that are typically external to the API server, the server itself is typically stateless and can be replicated to handle request load and provide fault tolerance. The API servers commonly provides API management (the process by which APIs are exposed and managed by the server), requests processing (the target set of functionality that processes individual API requests from a client), and provides internal control loops (provides internals responsible for background operations necessary to the successful operation of the API server).

In one implementation, the API server receives https requests from kubectl or any automation (go-client’s) to send requests to any kubernetes cluster. Users access the cluster using API server and it stores all the API objects into etcd. The master API server receives https requests from user interface (UI) or dmctl. This has a single endpoint of contact for all UI functionality. It shall validate the request and send the request to API server. An agent controller (not shown) can reside on each tenant cluster and perform actions in each cluster. Domain cluster components can use Kubernetes native or CustomResourceDefinitions (CRD) objects to communicate with the API server in the tenant cluster. The agent controller can handle the CRD objects.

In one implementation, the tenant clusters can run controllers such as HNC controller, storage agent controller, or agent controller. The communication between domain cluster components and tenant cluster are via the API server on the tenant clusters. The applications on the domain cluster can communicate with applications on tenant clusters and the applications on one tenant cluster can talk to applications on another tenant cluster to implement specific functionality.

Data storage 112 is normally configured as a database and stores data structures necessary to implement the functions of the application management server 108. For example, data storage 112 comprises objects and associated definitions corresponding to each tenant cluster, and project and references to the associated cluster definitions in data storage 118. Other objects/definitions include networks and endpoints (for data networking), volumes (created from a distributed data storage pool on demand),mirrored volumes (created to have mirrored copies on one or more other nodes), snapshots (a point-in-time image of a corresponding set of volume data, linked clones (volumes created from snapshots are called linked clones of the parent volume and share data blocks with the corresponding snapshot until the linked clone blocks are modified), namespaces, access permissions and credentials, and other service-related objects.

Namespaces enable the use of multiple virtual clusters backed by a common physical cluster. The virtual clusters are defined by namespaces. Names of resources are unique within a namespace but not across namespaces. In this manner, namespaces allow division of cluster resources between multiple uses. Namespaces are also used to manage access to application and service-related Kubernetes objects, such as pods, services, replication, controllers, deployments, and other objects that are created in namespaces.

Data storage 118 includes the data structures enabling cluster management by the master API server 114. In one implementation, data storage 118 is configured as a distributed key-value lightweight database. In Kubernetes, it is a central database for storing the current cluster state at any point of time and also used to store the configuration details such as subnets, configuration maps, etc.

The communication network 128, in some embodiments, can be any trusted or untrusted computer network, such as a WAN or LAN. The Internet is an example of the communication network 128 that constitutes an IP network consisting of many computers, computing networks, and other communication devices located all over the world. Other examples of the communication network 128 include, without limitation, an Integrated Services Digital Network (ISDN), the Public Switched Telephone Network (PSTN), a cellular network, and any other type of packet-switched or circuit-switched network known in the art. In some embodiments, the communication network 128 may be administered by a Mobile Network Operator (MNO). It should be appreciated that the communication network 128 need not be limited to any one network type, and instead may be comprised of a number of different networks and/or network types. Moreover, the communication network 128 may comprise a number of different communication media such as coaxial cable, copper cable/wire, fiber-optic cable, antennas for transmitting/receiving wireless messages, wireless access points, routers, and combinations thereof.

With reference now to FIG. 2, additional details of the application management server 108 will be described in accordance with embodiments of the present disclosure. The server 108 is shown to include processor(s) 204, memory 208, and communication interfaces 212a . . . n. These resources may enable functionality of the server 108 as will be described herein.

The processor(s) 204 can correspond to one or many computer processing devices. For instance, the processor(s) 204 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor(s) 204 may be provided as a microcontroller, microprocessor, Central Processing Unit (CPU), or plurality of microprocessors that are configured to execute the instructions sets stored in memory 208. Upon executing the instruction sets stored in memory 208, the processor(s) 204 enable various centralized management functions over the tenant clusters.

The memory 208 may include any type of computer memory device or collection of computer memory devices. The memory 208 may include volatile and/or non-volatile memory devices. Non-limiting examples of memory 208 include Random Access Memory (RAM), Read Only Memory (ROM), flash memory, Electronically-Erasable Programmable ROM (EEPROM), Dynamic RAM (DRAM), etc. The memory 208 may be configured to store the instruction sets depicted in addition to temporarily storing data for the processor(s) 204 to execute various types of routines or functions.

The communication interfaces 212a ... n may provide the server 108 with the ability to send and receive communication packets (e.g., requests) or the like over the network 128. The communication interfaces 212a ... n may be provided as a network interface card (NIC), a network port, drivers for the same, and the like. Communications between the components of the server 108 and other devices connected to the network 128 may all flow through the communication interfaces 212a ... n. In some embodiments, the communication interfaces 212a . . . n may be provided in a single physical component or set of components, but may correspond to different communication channels (e.g., software-defined channels, frequency-defined channels, amplitude-defined channels, etc.) that are used to send/receive different communications to the master API server 112 or API server 152.

The illustrative instruction sets that may be stored in memory 208 include, without limitation, in the infrastructure and application management (management plane) 124 include the project controller 216, application mobility and disaster recovery controller 220, cluster controller 224, policy controller 228, tenant controller 232, application controller 236, and master authenticator 240 and, in the stateful data and application services (data plane) 124, distributed storage controller 244, networking controller 248, data protection disaster recovery/DP 252, drivers 256, container integration 260, and virtualization tool 264. Functions of the application management server 108 enabled by these various instruction sets are described below. Although not depicted, the memory 208 may include instructions that enable the processor(s) 204 to store data into and retrieve data from data storage 114 and 118.

It should be appreciated that the instruction sets depicted in FIG. 2 may be combined (partially or completely) with other instruction sets or may be further separated into additional and different instruction sets, depending upon configuration preferences for the server 108. Said another way, the particular instruction sets depicted in FIG. 2 should not be construed as limiting embodiments described herein.

In some embodiments, the instructions for the project controller 216, when executed by processor(s), may enable the server 108 to control, on a project-by-project basis, the resource utilization based on project members and control things such as authorization of resources within a project or across other projects using a network access control list (ACL) policies. The project causes grouping of resources such as memory, CPU, storage and network and quota of these resources. The project members view or consume resources based on authorization policies. The projects could be on only one cluster or span across multiple or different clusters.

In some embodiments, the instructions for the domain/tenant cluster controller 224, when executed by processor(s), may enable the server 108 to control provisioning of cloud-specific clusters and manage their native Kubernetes clusters. Other cluster operations that can be controlled include:
adopting an existing cluster;
removing the cluster from the server 108;
upgrading a cluster;
creating cluster; and
destroying the cluster.

The domain and tenant cluster controller can be an independent application developed using the operator framework.

In one implementation, the domain/tenant cluster controller enables setting up of a domain cluster, where all the required domain cluster services such as cluster manager, configdb(etcd), auth controller, tenant, project controller, migration controller, etc., shall be brought up. For any newly created or existing clusters, users can choose to join an existing domain. Tenant clusters can be administered using dmctl cluster commands.

In some embodiments, the instructions for the master authenticator 240, when executed by processor(s), may enable the server 108 to implement authentication and authorization on the master API server. In one implementation, authentication verifies the credentials of the user and establishes the identity of the user. Authorization policies govern access rights to resources. The master authenticator manages both authentication and authorization for users. The master authenticator can also We are also going to standardize on JSON Web Tokens as a way to communicate authorization among internal server components and services. This approach allows the verifying client to perform token verification locally without contacting the central authorization service. Local verification will be achieved using public/private key Rivest-Shamir-Adleman (RSA) mechanism.

In some embodiments, instructions for the application mobility and disaster recovery controller 220 (at the management plane) and the data protection disaster recovery/DP 252 (at the data plane), when executed by processor(s), may enable the server 108 to implement containerized or VM-based application migration from one cluster to another cluster using migration agent controllers on individual clusters. For example, the controller 220 can migrate applications (both stateful and stateless) seamlessly from on-premises to cloud and vice-versa across clusters and monitor application migration lifecycle (initializing, pending migrating, etc.). The controller 220 can thereby provide flexibility to move applications based on cost4/data needs (i.e., if running an application on a cloud provider is proving to be expensive, then move it to on-premises or another cloud provider; reduce application downtime in case of cluster maintenance or upgrade, and migrate applications from staging to production cluster (or development to quality assurance to production) seamlessly through multi-cluster. The controller 252 could include a snapshot subcontroller to take periodic snapshots and a cluster health monitoring subcontroller running at the domain cluster to monitor health of containers.

In one implementation, the application mobility and disaster recovery controller effects stateless application migration by deleting the application on the source cluster and creating a new instance of the application on the destination cluster. Stateful application migration requires data migration prior to migrating application. The controller performs the following operations during the migration process:
updates ApplicationConfig object to delete the application on the source cluster;
for stateful applications, setup volume migration by creating a Migration config object and wait for the volume migration to complete; and
updates an ApplicationConfig obj ect to create the application on the destination cluster.

In some embodiments, instructions for the application controller 236, when executed by the processor(s), may enable the server 108 to deploy applications, effect application failover/fallback, application cloning, cluster cloning, and monitoring applications. In one implementation, the application controller enables users to launch their applications from the server 108 on individual clusters or a set of clusters using a kubectl command.

In one implementation, the application controller performs following operations:
watches for the application creation and deletion;
schedules the application to the tenant cluster based on resource requirements;
creates, updates and deletes application on the tenant cluster;
updates the status of the application; and
reconciles the application on the tenant cluster.

Tenant clusters are accessed with the kube-config stored in the domain cluster as a kubernetes secret. Each cluster’s kubeconfig is stored with the name “<cluster-name>kubeconfig” in the tenant’s namespace on the Domain cluster. For Example: Cluster1 managed by spektra domain cluster contains a secret with the name “cluster1-kubeconfig” in the tenant’s namespace.

In some embodiments, instructions for the policy controller 228, when executed by the processor(s), may enable the server 108 to effect policy-based management, whose goal is to capture user intent via templates and enforce them declaratively for different applications, nodes, and clusters. An application may specify a policy P1 for an application. The policy controller can manage policy definitions and propagate them to individual clusters. The policy controller can interpret the policies and give the policy enforcement configuration to corresponding feature specific controllers. The policy controller could be run at the tenant cluster or at the master node based on functionality. As an example, the policy controller receives application and policy P1. To implement a snapshot policy, the policy manager can determine volumes that need snapshots and make the snapshot controller configuration, which will be propagated to the cluster hosting volumes. The snapshot controller in cluster will keep taking periodic snapshots as per the configuration requirements. In the case of a cluster health monitoring controller, the policy controller can send the configuration to that health monitoring controller on the domain cluster itself.

Other examples of policy control include application policy management (e.g., containerized or VM-based application placement, failover, migration, and dynamic resource management), storage policy management (e.g., storage policy management controls the snapshot policy, backup policy, replication policy, encryption policy, etc. for an application), network policy management, security policies, performance policies, access control lists, RBAC, and policy updates.

In some embodiments, the instructions for the distributed storage controller 244, when executed by processor(s), may enable the server 108 to perform storage configuration, management and operations such as storage migration/replication/backup/snapshots, etc.

In some embodiments, the instructions for the networking controller 248, when executed by processor(s), may enable the server 108 to enable multi-cluster or container networking (particularly at the data link and network layers) in which services or applications run mostly on one cluster and, for high availability reasons, use another cluster either on premises or on the public cloud. The service or application can migrate to other clusters upon user request or for other reasons. In most implementations, services run in one cluster at a time. The network controller 248 can also enable services to use different clusters simultaneously and enable communication across the clusters. The networking controller 248 can attach one or more interfaces (programmed to have a specific performance configuration) to a selected container while maintaining isolation between management and data networks. This can be done by each container having the ability to request one or more interfaces on specified data networks. The networking controller 248 further enables a management network (e.g., a static subnet for each node) for containers allowing service discovery. In one implementation, the networking capabilities rely on the use of two related objects, namely networks and endpoints.

In some embodiments, the instructions for the drivers 256, when executed by processor(s), may enable the server 108 to provide a common API (via the Container Networking Interface) for connecting containers to an external network and expose (via the Container Storage Interface) arbitrary block and file storage systems to containerized or VM-based workloads.

In some embodiments, the instructions for the container integration 260, when executed by processor(s), may enable the server 108 to provide (via OpenShift) a cloud-based container platform that is both containerization software and a platform-as-a-service (PaaS).

In some embodiments, the instructions for the virtualization tool 264, when executed by processor(s), may enable the server 108 to provide virtualization functionality to containers (such as via KVM - a hypervisor for the Linux operating system).

### Disaster Recovery

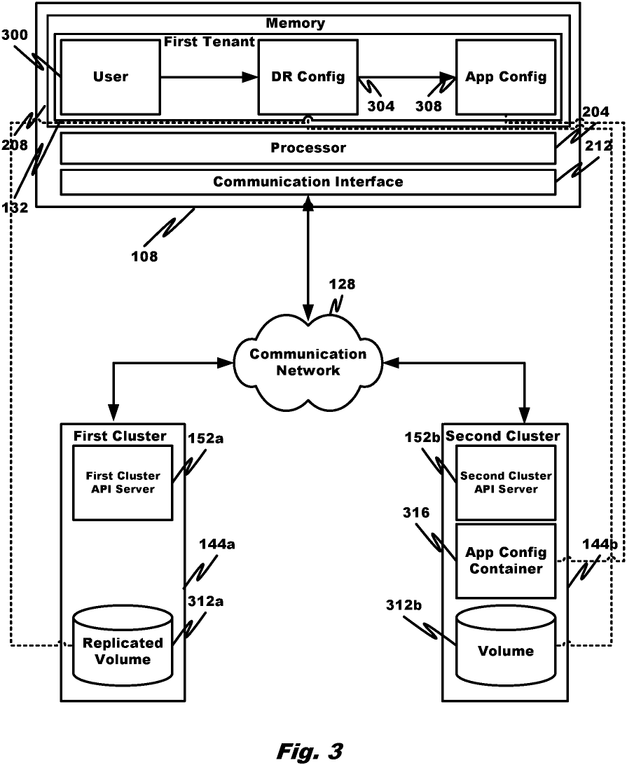

The disaster recovery functionality of the application mobility and DR/DP controller 220 will now be discussed with reference to FIGS. 3-6. The controller 220 can provide disaster recovery protection of stateful applications by replicating its data from a source cluster to a target cluster and controlling application failover/failback across them. The controller 220 or system administrators can set up application replication policies for disaster recovery of stateful applications to another cluster, provide one-click automated disaster recovery (failover and failback) for stateful applications, protect applications across multiple locations with integrated application-level disaster recovery and ensure business continuity, and set recovery point objectives between bare metal on-premises and public cloud for site-to-site disaster recovery.

Generally, the controller 220 creates one or more replicated volumes to ensure that there is little or no loss of data if a node or drive or other resource in a cluster fails. This is done by taking timestamped snapshots, or point-in-time images, of a corresponding volume of data, and storing the snapshots in the replicated volume. A replicated volume refers to asynchronous cross-cluster data protection. In contrast, volumes within a common cluster created from snapshots are referred to as linked clones of the parent volume from which the snapshots are derived. Linked clones share data blocks with the corresponding snapshot until the linked clone blocks are modified. Linked clones can be attached to any node in a common cluster.

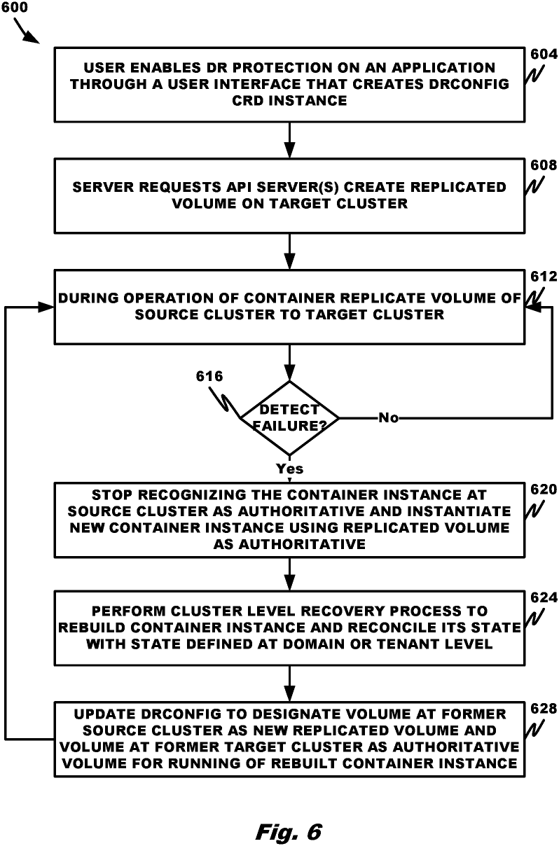

FIG. 6 depicts a disaster recovery process 600 resulting from execution of the controller 220.

In step 604, the controller 220 receives input from a user 300 to enable disaster recovery protection on an application through a user interface that creates a DRConfig instance on the data plane level. DRConfig includes: the name of the application to be subject to DR, the source cluster, the target cluster, the desired network on the source cluster, the desired network on the target cluster, and the project associated with the application. Effectively, DR Config, when applied to any application, defines where (what volume) the data is to be asynchronously stored in and at what time interval the data is to be updated. App Config contains the container template and includes, for example, static asset descriptions. As will be appreciated, these parameters are modeled through custom resources in the Kubernetes API.

In step 608, the controller 220, in response, requests the API servers 152a and 152b on the target clusters, respectively, to create replicated volume. With reference to FIG. 3, the first cluster 144a is the target cluster and the second cluster 144b is the source cluster. To enable DR protection on the application, the controller 220 typically determines the PersistentVolumeClaims (PVCs) used by the application. A PersistentVolumeClaim (PVC) is a request for storage by a user. It is similar to a Pod. Pods consume node resources and PVCs consume PV resources. Pods can request specific levels of resources (CPU and Memory). Claims can request specific size and access modes (e.g., they can be mounted ReadWriteOnce, ReadOnlyMany or ReadWriteMany).

The controller 220 then sends the following operations to the API server 144a on the first or target cluster 144a:
1) Create corresponding PVCs (of exactly same size and same or different name);
2) Create PVCGroup Controller (CR) (with the corresponding PVCs created in step 1); and
3) Create Replication Controller (CR).

The target or first cluster 144a would create a replication controller which includes creation of container service matching address (e.g., domain name) and assigning an IP address to it (the IP address would be routable from the source cluster to the target cluster). As will be appreciated, the replication controller in this example can be replaced with replica sets, which is a current replacement for replication controller replication.

The controller 220 then sends the following operations to the API server 144b on the second or source cluster 144a:
1) Create PVCGroup CR (using PVCs used by the application); and
2) Create Replication CR on the source cluster (which has target replication service address).

The source cluster dataservice-operator would have resolved the target address) through a Delegated Machine Credentials (DMC) service-discovery service.

During the DR protection enable or create lifecycle, DRConfig, transitions through the following phases:
1. Pending: When a DR enable request is initiated, it is set to be in the Pending phase. During this phase, the controller validates the configuration and ensures the clusters are available for DR enablement.
2. Initializing_Target: Initiate PVCs, PVCGroup, Replication CR creation on target and wait for completion.
3. Initializing_Source: Initiate PVCGroup, Replication CR creation on source and wait for completion.
4. Completed: Indicates the DR protection enable completion.
5. Failed: Indicates the DR protection enable operation failed.

When the DR enable request is completed, the state of the application is shown in FIG. 3. As shown by the dotted line, the DR Config. File is linked to each of the replicated volume 312a in the first or target cluster 144a and the authoritative volume 312b for the application in the second or source cluster 144a. During running of the application, snapshots of the volume 312b are periodically created, changed blocks are replicated, and snapshot metadata is recreated on the destination or target cluster. Depending on the frequency of snapshot generation (which is a configurable parameter), some latency will exist between the states of the volume 312b and replicated volume 312a. In addition, as shown by the dotted line the App Config file, which defines the container for the application, is linked to the app config container 316.

With continuing reference to FIGS. 3 and 6, the controller 220 determines, in decision diamond 616, whether or not the application is not running properly, such as due to failure of a node or drive. This can be done automatically by the controller 220 or through user input received via the user interface indicating that a failure has occurred. When the application is running properly, the controller 220 returns to step 612. When the application is not running properly, the controller 220 proceeds to step 620.

In step 620, the controller 220 notifies the second cluster API server 152b to stop considering the app config. Container and volume as authoritative and the first cluster API server 152a to instantiate a new container instance in accordance with the App Config file and using the replicated volume 312a as authoritative.

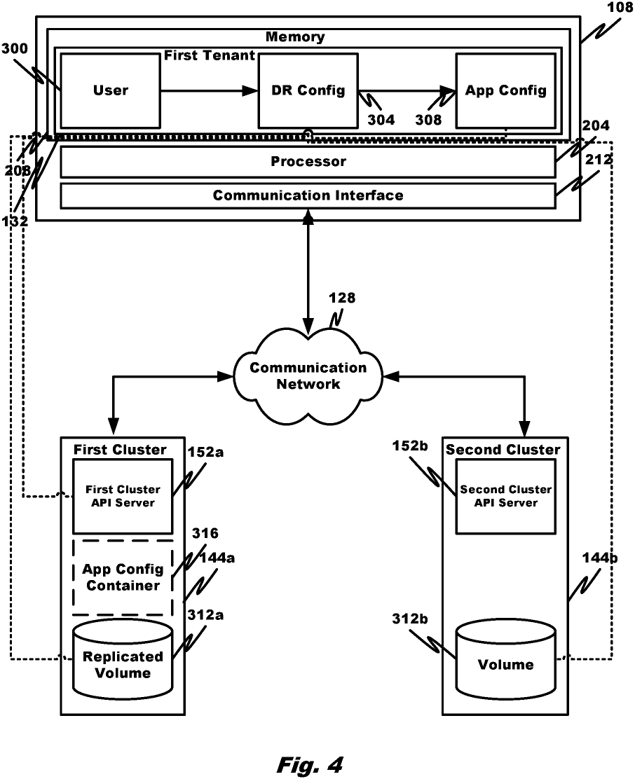

In step 624, the controller 220 performs a cluster level recovery process to rebuild the container instance and reconcile its state with the state defined at the domain or tenant level. The state is defined by the App Config file and snapshots stored in the replicated volume 312a. The most recent snapshot stored in the volume is used. With reference to FIG. 4, the server 220, as shown by the changed position of the dotted line between the App Config file and App Config container instance, has initiated creation of a new instance of the app config. Container 312 in the first cluster 144a.

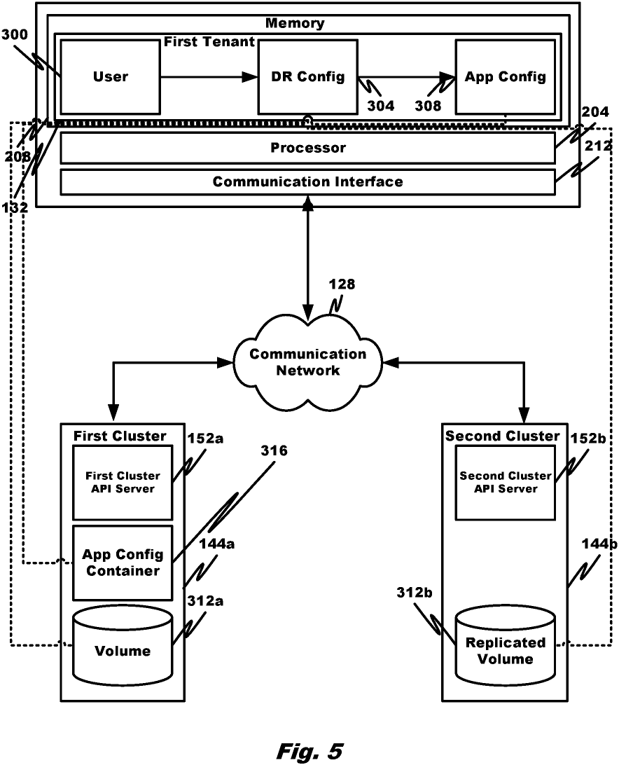

In step 628, the server 220 updates DR Config file to designate the volume 312a as the parent volume and the volume 312b as the linked clone or replicated volume. The controller 220 sends the update to the first cluster server and/or second cluster server. As shown by FIG. 5, the App Config container instance has been successfully rebuilt on the first cluster and is storing, as linked clones, volumes generated from snapshots with the volume 312b acting as the replicated volume.

Other controller 220 DR operations include:

Disable (Remove) DR Protection (of an application), which includes the API server requests Delete Replication CR, PVCGroup CR, service address on the target cluster and Delete Replication CR, PVCGroup CR on the source cluster;

Update DR Config (of an application), which includes the API server requests: send update operation to the target and/or source clusters.

Reconcile DR Config on change in “No of PVCs” used by its application, which includes the API server requests:
1. Create/Delete corresponding PVCs on the target cluster;
2. Update PVCGroup on the target cluster (to include/exclude PVCs in/from it);
3. Send updated Replication CR to the target cluster;
4. Update PVCGroup on the source cluster (to include/exclude PVCs in/from it); and
5. Send updated Replication CR to the source cluster.

Pause/Resume DR (of an application), which includes the API server request to change Replication CR AdminState to Pause/Resume and send to the source cluster.

Reconcile DR Config on increase in “Size of PVCs” used by its application, which includes resize corresponding PVCs on the target cluster.

### Authentication

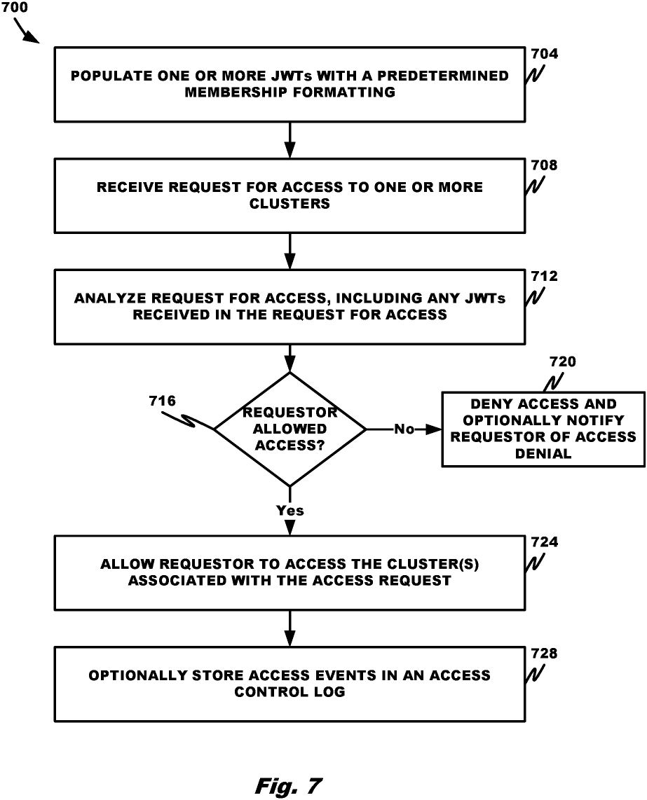

Authentication capabilities and management thereof will now be described with reference to FIG. 7. RBAC may allow access control management on kubernetes resources.

In order to link user roles to RBAC, it may be desirable to declare user designations stamped on their j son web identity tokens (JWT). This can be done via formatting the membership of a user to a tenant and access level to a project within that tenancy using a hierarchical pattern such as /spektra/<tenant-name>/project/<project-name>/<role-name>.

JWTs may include a list of such strings associated with an user entity. Each of these strings then has a one-to-one correspondence with groups defined in any particular kubernetes cluster. An authentication webhook may be used to perform the duties of intercepting incoming user JWT token and populating kubernetes roles using this scheme.

In some embodiments, an authentication method 700 may include first populating one or more JWTs with a predetermined membership formatting (step 704). The formatting may include one or more fields such as tenant-name, project-name, role-name, etc. In some embodiments, the formatting of the one or more JWTs may help control access to only a particular set of clusters or resources.

The method may continue with an access request being received at the master authenticator 240 (step 708). The master authenticator may analyze the access request, possibly including the JWT included in the access request, to determine if the request for access is received from an entity having access permissions for the cluster(s) associated with the access request (step 712).

The method 700 may continue with the master authenticator 240 determining whether or not the JWT included in the access request corresponds to a valid JWT that is allowed access to the cluster(s) associated with the access request (step 716).

In the event that the query of step 716 is answered negatively, the master authenticator 240 may return an error or access denial message to the requesting entity (step 720). In the event that the query of step 716 is answered positively, the master authenticator 240 may allow access to the cluster(s) associated with the access request (step 724). In some embodiments, the access event and any subsequent events associated with the access may be stored in an access control log, which may be maintained by the master authenticator 240 (step 728).

While access control and authentication may be performed with respect to an entity requesting access to a cluster or resources associated with a cluster, it should be appreciated that authentication may be performed at different levels of the architecture. For instance, Spektra may include one or more micro-services and some of these services are not natively aware of authentication. In order to provide authentication-based access control on such services it may be desirable to provide a middleware that intercepts the HTTP request going to such services and based on the URI path, determine the virtual representation of the destination service by its equivalent path in Vault (the authentication agent or master authenticator 240). A simple read operation may then be performed on the virtual representation of the service in Vault and based on successful authorization, the HTTP request is forwarded downstream.

For instance, a particular user entity may only have access to project A but not project B. While data for both projects in stored in service C, user should be denied access to data for project B. So the incoming JWT ID token of the user is used to perform a read operation on an internal representation of the service at /spektra/<tenant-name>/service/<service-name>/project/<project-name>. If read operation succeeds, HTTP request is forwarded downstream. If the read operation fails, then the HTTP request is not forwarded.

### Policy-Based Management

In one embodiment the policy controller 228 creates, communicates, and maintains policies and procedures in organizations that manage distributed systems, such as tenant clusters 132. The policy controller 228 can implement consistently and continuously legal requirements and compliance by organization decisionmakers in an automated and artificially intelligent manner, even in complex systems. The policy controller 228 can use International Engineering Task Force (IETF)-based management functional elements, such as policy management tools to create, update, and verify policies, a policy repository, a policy decision point to authenticate, validate, and communicate violations and other abnormalities to policy enforcement points for appropriate action.

In one embodiment, the policy controller 228 creates, communicates, and maintains policies, or sets of rules, at the service provider, tenant, project, and application levels (in order of priority). The policies flow, or are hierarchically ranked by different integer values, from the top or service provider level to the bottom or application level. Policies can be further identified as being available (e.g., optional but not compliance required) or enforced (compliance required). Applications can specify any new policies that are available to the application; however, policies do not flow from the bottom to the top levels. Stated differently, a lower level policy is superseded by a conflicting or overlapping higher level policy (or policy of a common type) and not vice versa.

The policies each correspond to a set of rules and a policy state. The policy state can correspond to a particular object configuration and/or define at an object level objects to operate on or implement defined policies. Objects can be for instance a tenant cluster 132, API server 152, project 140, cluster 144, application 148, or any other object defined by the policy controller 228.

The policies can be of different types. For example, policies can define sets of rules for storage (e.g., replication, backup, deduplication, compression, over-provisioning, and the like); network (e.g., connectivity between namespaces with Open vSwitch (OVS)), security (e.g., encryption for storage, network, and cryptographic key management), resource limits (e.g., application usage maximum or minimum limits and the like), performance policies (e.g., high, medium, or best), and other or generic policies (e.g., allowing graphics processing unit (GPU) nodes to subscribed tenants, upgrades, version enforcements, and the like). As set forth below, policy explosion can be avoided and policy simplification realized by combining feature specific policies into a top level policy.

For a given service provider, policies can be merged by the policy controller 228 based on a value in the PolicyType field and hierarchical level to enforce the desirable intent on an application. Each policy type (or feature specific policy) can be assigned a different value (such as an integer value), and each of the service provider, tenant, project, and application hierarchical levels can be assigned a different value (such as an integer value). The policy controller 228 can select a given type of policy, determine which policies of that type are present at all hierarchical levels, and which of the policies of that type are enabled (as opposed to disabled) for enforcement. Where plural policies of a common type are enabled and present at different hierarchical levels, the enabled policy at the higher hierarchical level trumps or supersedes the enabled policy at the lower hierarchical level. This query is performed policy type-by-policy type until all policy types have been considered. The resulting merged or combined policies are then enforced by the policy controller 228, typically at a lowest level of the merged policy types to avoid a policy being escalated for enforcement at a higher level than intended.

A different top level or aggregate policy can exist for every hierarchical level and for different objects at each hierarchical level. For example, different aggregate policies can exist for different service providers, different domain clusters 104, different tenant clusters 132, different clusters 144a, different projects 140, and different applications 148. In each case, a hierarchical level or object is selected and the steps in the prior paragraph performed for that selected hierarchical level or object subject to the rules set forth above, e.g., policies do not flow from the bottom to the top levels, a lower level policy is superseded by a conflicting or overlapping higher level policy or policy of a same type and not vice versa, and a policy is not enforced at a higher hierarchical level than originally configured or intended.

Policy exclusion can thus be avoided by combining feature specific policies into a top level policy. For example, a first policy of a first type can be combined with a second policy of a different and nonconflicting type to form a top level policy for enforcement at multiple levels. By way of illustration, a storage policy can be combined with a security policy to form a top level policy for enforcement at multiple levels. The combined policies can be from different hierarchical levels depending on application. Stated differently, a first policy of a first type from a first level can be merged with a second policy of a second type from a second level to form the top level policy that is enforced at a lower of the first and second levels and at lower hierarchical levels.

An exemplary policy definition includes the following fields: SPName or service provider name, TenantName, ProjectName, Selector (or service provider representative selecting the policy), PolicyCondition (e.g., enabled or enforceable or disabled or unenforceable), and ReplicationPolicy. ReplicationPolicy can include the further fields: Schedule or the replication schedule (e.g., frequency or timing of replication), Mode (synchronous, asynchronous, or periodic replication), FailoverPolicy (e.g., automatic or manual failover), and FailbackPolicy (e.g., automatic or manual failback). Policies can be created, updated, or deleted by appropriate kubectl commands.

Policies can be used in different ways. For example, policies can used to specify policies and state in a project by using the fields: for ProjectSpec (or policy specification) -ProjectPolicyState (or project configuration and state), available policies, or enforced policies; for ProjectReplicationState (or project replication state) - RemoteClusters and SnapshotPromoter (e.g., the name of the promoter); and for ProjectPolicyState (or project policy state) - ProjectStorageState (e.g, replication or backup). Policies can also be used to specify additional policies in applications by using the field ApplicationConfigSpec to add the following field - Policies string //List.

The ProjectPolicyState field can comprise a checksum of generated policies based on policy type. As will be appreciated, a checksum is a small-sized block of data derived from another block of digital data for the purpose of detecting errors that may have been introduced during its transmission or storage. The procedure which generates this checksum is called a checksum function or checksum algorithm, such as a parity byte or parity word, sum complement, position-dependent, position-dependent, and fuzzy checksum algorithms. Verifying the checksum helps in validating that that the accessed policies of a selected policy type are the same as the generated policies of the selected policy type. The checksum value should be the same for the accessed policies of a selected policy type and the generated policies of the selected policy type. If the checksum value is not same, then the different values indicates that the accessed policies of a selected policy type and the generated policies of the selected policy type are out-of-sync.

The application controller 236 defines the desired state of the ApplicationConfig data structure. The data structure commonly includes the fields: Action string (‘json:”action.omitempty”’), ClusterSelector (map[string]string ‘json:“clusterSelector,omitempty”’), Clusters ([]string ‘json: “clusters,omitempty”’), TenantName (string ‘json:“tenantName,omitempty”’), ProjecName (string ‘json:“projectName,omitempty”’), ResourceTemplate (string ‘json:“resourceTemplate,omitempty”’), Configs(string []map[string]interface{} ‘json:“configs,omitempty”’), Helm (^{∗}HelmConfig ‘json:“helm,omitempty”'), and Policies ([]string json”policies,omitempty”’). The application controller 236 generates an aggregated final policy, or rule set, for the application by merging a stack, or plurality, of policies. The merged policies typically include all enforced policies from the tenant and project and any new set of policies specified in the application. The application controller 236 can monitor for application object changes and adapts to the policy changes resulting from the object changes.

The policy controller 228 monitors for policy changes in the system 100, propagates the change to the Custom Resource Definition (CRD) controllers (including identifying the policy change and effected Custom Resource (CR) instances, notifies the CRD controller for every CR instance, and increments the metadata Generation or generic way. In some applications, feature controllers manage policy changes in case scalability is an issue. As will be appreciated, a custom resource allows a user to create your own API objects and define a desired kind of API object for an application. The policy controller 228 further includes one or more feature controllers (not shown) to manage policy changes in case scalability is an issue.

Default policy configurations vary by application. In one embodiment, default policy configurations include: replication configuration of storage volumes for applications to enable manual disaster recovery for applications and encryption key management. Typically; all applications in a project namespaces on a tenant cluster can communicate (default), and there are no enforced policies at the service provider/tenant levels. Policies can be defined at the project level; and only one policy applies per application. No merging of policies is typically enabled in the default configuration.

In backup policy definition, the policy specification or PolicySpec data structure includes the fields: SPName or service provider name, TenantName, ProjectName, Selector, PolicyCondition, StoragePolicyName, NetworkPolicyName, and SecurityPolicyName.

The storage policy includes a number of data structures including: StoragePolicySpec includes the Selector, PolicyCondition (enable or disable), ReplicationPolicy, and BackupPolicy fields, while ReplicationPolicy includes the Schedule (replication schedule), Mode (synchronous, asynchronous, or periodic), FailoverPolicy (automatic or manual), and FailbackPolicy (automatic or manual) fields.

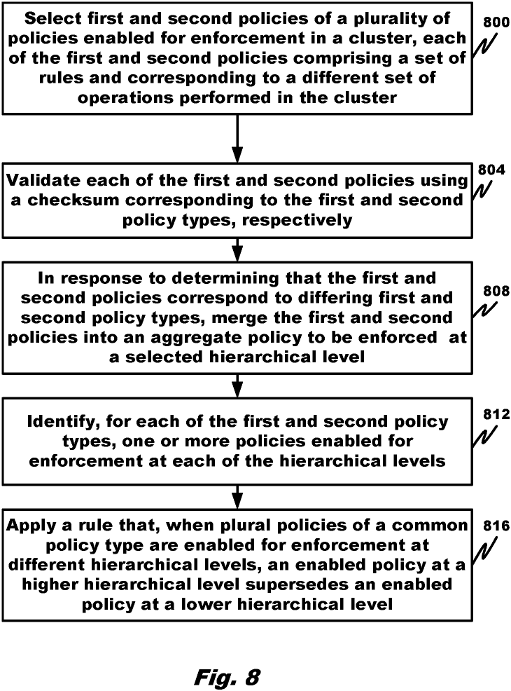

Policy management will now be described with reference to FIG. 8. The policy controller 228 selects first and second policies of a plurality of policies enabled for enforcement in a cluster, each of the first and second policies comprising a set of rules and corresponding to a different set of operations performed in the cluster (step 800). The policy controller 228 validates each of the first and second policies using a checksum corresponding to the first and second policy types, respectively (step 804). In response to determining that the first and second policies correspond to differing first and second policy types, the policy controller 228 merges the first and second policies into an aggregate policy to be enforced at a selected hierarchical level (step 808). The policy controller 228 identifies, for each of the first and second policy types, one or more policies enabled for enforcement at each of the hierarchical levels (step 812). The policy controller 228 applies a rule that, when plural policies of a common policy type are enabled for enforcement at different hierarchical levels, an enabled policy at a higher hierarchical level supersedes an enabled policy at a lower hierarchical level (step 816).

The exemplary systems and methods of this disclosure have been described in relation to cloud computing. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments , configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of enabling policy management in a multi-cluster cloud computing environment, the method comprising:
selecting first and second policies of a plurality of policies enabled for enforcement in a cluster, each of the first and second policies comprising a set of rules and corresponding to a different set of operations performed in the cluster, wherein first and second sets of operations correspond to the first and second policies, respectively, and define, respectively, differing first and second policy types;
in response to determining that the first and second policies correspond to differing first and second policy types, merging the first and second policies into an aggregate policy to be enforced at a selected hierarchical level.

2. The method of claim 1, wherein the selected hierarchical level comprises one or more of service provider, tenant, project, and application.

3. The method of claim 2, wherein the first and second policies correspond to different first and second hierarchical levels, respectively, wherein the selected hierarchical level is a higher of the first and second hierarchical levels, and wherein the aggregate policy is enforced at one or more hierarchical levels below the selected hierarchical level.

4. The method of claim 3, further comprising
identifying, for each of the first and second policy types, one or more policies enabled for enforcement at each of the hierarchical levels; and
applying a rule that, when plural policies of a common policy type are enabled for enforcement at different hierarchical levels, an enabled policy at a higher hierarchical level supersedes an enabled policy at a lower hierarchical level.

5. The method of claim 1, wherein the first and second policy types correspond to differing ones of storage, network, security, resource limit, and performance.

6. The method of claim 1, wherein each of the first and second policies corresponds to a policy state, the corresponding policy state comprising a checksum of generated policies based on the corresponding policy state, and further comprising:
validating each of the first and second policies using a checksum corresponding to the first and second policy types, respectively.

7. A system for enabling policy management in a multi-cluster cloud computing environment, the system comprising:
a communication interface to transmit and receive communications;
a processor coupled with the communication interface; and
a computer readable medium, coupled with and readable by the processor and storing therein a set of instructions that, when executed by the processor, causes the processor to:
select first and second policies of a plurality of policies enabled for enforcement in a cluster, each of the first and second policies comprising a set of rules and corresponding to a different set of operations performed in the cluster, wherein first and second sets of operations correspond to the first and second policies, respectively, and define, respectively, differing first and second policy types;
in response to determining that the first and second policies correspond to differing first and second policy types, merge the first and second policies into an aggregate policy to be enforced at a selected hierarchical level.

8. The system of claim 7, wherein the selected hierarchical level comprises one or more of service provider, tenant, project, and application.

9. The system of claim 8, wherein the first and second policies correspond to different first and second hierarchical levels, respectively, wherein the selected hierarchical level is a higher of the first and second hierarchical levels, and wherein the aggregate policy is enforced at one or more hierarchical levels below the selected hierarchical level.

10. The system of claim 9, wherein the processor
identifies, for each of the first and second policy types, one or more policies enabled for enforcement at each of the hierarchical levels; and
applies a rule that, when plural policies of a common policy type are enabled for enforcement at different hierarchical levels, an enabled policy at a higher hierarchical level supersedes an enabled policy at a lower hierarchical level.

11. The system of claim 7, wherein the first and second policy types correspond to differing ones of storage, network, security, resource limit, and performance.

12. The system of claim 7, wherein each of the first and second policies corresponds to a policy state, the corresponding policy state comprising a checksum of generated policies based on the corresponding policy state, and wherein the processor:
validates each of the first and second policies using a checksum corresponding to the first and second policy types, respectively.

13. A multi-tenant, multi-cluster environment comprising:
a plurality of tenant clusters; and
a domain cluster communicatively coupled with each of the plurality of tenant clusters, the domain cluster comprising a processor and a memory coupled with and readable by the processor and storing therein a set of instructions which, when executed by the processor, causes the processor to:
select first and second policies of a plurality of policies enabled for enforcement in a cluster, each of the first and second policies comprising a set of rules and corresponding to a different set of operations performed in the cluster, wherein first and second sets of operations correspond to the first and second policies, respectively, and define, respectively, differing first and second policy types;
in response to determining that the first and second policies correspond to differing first and second policy types, merge the first and second policies into an aggregate policy to be enforced at a selected hierarchical level.

14. The multi-tenant, multi-cluster environment of claim 13, wherein the selected hierarchical level comprises one or more of service provider, tenant, project, and application.

15. The multi-tenant, multi-cluster environment of claim 14, wherein the first and second policies correspond to different first and second hierarchical levels, respectively, wherein the selected hierarchical level is a higher of the first and second hierarchical levels, and wherein the aggregate policy is enforced at one or more hierarchical levels below the selected hierarchical level.

16. The multi-tenant, multi-cluster environment of claim 15, wherein the processor
identifies, for each of the first and second policy types, one or more policies enabled for enforcement at each of the hierarchical levels; and
applies a rule that, when plural policies of a common policy type are enabled for enforcement at different hierarchical levels, an enabled policy at a higher hierarchical level supersedes an enabled policy at a lower hierarchical level.

17. The multi-tenant, multi-cluster environment of claim 13, wherein the first and second policy types correspond to differing ones of storage, network, security, resource limit, and performance.

18. The multi-tenant, multi-cluster environment of claim 13, wherein each of the first and second policies corresponds to a policy state, the corresponding policy state comprising a checksum of generated policies based on the corresponding policy state, and wherein the processor:
validates each of the first and second policies using a checksum corresponding to the first and second policy types, respectively.
